(19) United States
(12) Patent Application Publication
(10) Pub. No.: US 2012/0077449 A1
(43) Pub. Date: Mar. 29, 2012

(54) RADIO FREQUENCY POWER AMPLIFIER

(75) Inventors: Kazuhiko OHASHI, Osaka (JP); Shingo ENOMOTO, Osaka (JP)

(73) Assignee: PANASONIC CORPORATION, Osaka (JP)

(21) Appl. No.: 13/241,709

(22) Filed: Sep. 23, 2011

(30) Foreign Application Priority Data
Sep. 29, 2010 (JP) 2010-218182

(51) Int. Cl. H04B 1/04

(52) U.S. Cl. 455/114.3

(57) ABSTRACT

The present invention offers a radio frequency module having a radio frequency power amplifier and a directional coupler integrated in a multi-layer board, and in particular, a small, inexpensive, and high-performance radio frequency module, and a small and inexpensive wireless device equipped with the radio frequency module. The radio frequency module includes: a multi-layer board; a radio frequency power amplifier formed on top of the multi-layer board; a directional coupler having two layers vertically arranged in the multi-layer board; an internal ground pattern provided between the radio frequency power amplifier and the directional coupler; and thermal vias used for the radio frequency power amplifier and provided (i) between the internal ground pattern and a rear surface ground pattern and (ii) between the directional coupler and a bias line which is (i) provided in the same layer as the directional coupler and (ii) used for the radio frequency power amplifier.

### BACKGROUND OF THE INVENTION

(1) Field of the Invention

The present invention relates to radio frequency modules used for devices transmitting and receiving radio frequency signals.

(2) Description of the Related Art

In the field of recent mobile communications, complex mobile-phone terminals, having two or more communication modes and frequency bands integrated, are going the mainstream of mobile communications terminals. Since such a complex mobile communications terminal employs various communication modes and frequencies to be used as carrier waves, a radio frequency circuit block is required for each communication mode and frequency in order for the radio frequency circuit block to correspond to the communication mode and the frequency of each carrier wave. This causes the mobile communications terminal to be greater in size. In order to build smaller mobile communications terminals, there are important factors to take: (i) the reduction of the number of components on a mobile communications terminal substrate, and (ii) a smaller wireless circuit unit.

Described hereinafter is a typical mobile-phone terminal which complies with the Wideband-Code Division Multiple Access (W-CDMA).

FIG. 3 is a block diagram showing a structure of a wireless unit in the mobile-phone terminal. As shown in FIG. 3, the wireless unit of the mobile-phone terminal includes a transmitting unit 120, a receiving unit 121, and a shared unit 122.

The W-CDMA transmitting unit 120 includes a radio frequency integrated circuit (RFIC) 107, a band-pass filter 108, a radio frequency power amplifier 109, a directional coupler 110, and an isolator 111. The RFIC 107 converts a modulating signal, which enters a baseband unit 106 controlling a transmitting signal, into a transmitting signal in a transmit frequency. The band-pass filter 108 extracts a signal in a transmitter pulse band. The radio frequency power amplifier 109 amplifies a radio frequency signal (equal to or smaller than 10 mW) provided from the band-pass filter 108 up to approximately 1 W. The directional coupler 110 monitors the output of the radio frequency power amplifier 109. The isolator 111 conducts the radio frequency signal, provided from the directional coupler 110, in only one direction toward the shared unit 122. Recently, however, band-pass filters and isolators are disappearing because RFICs and radio frequency power amplifiers show improvement in their capacities and are operated on new control techniques. The shared unit 122 includes an antenna 114, a switch 113, and a duplexer 112. The duplexer 112 includes a TX terminal, an RX terminal and an SW terminal. The TX terminal is connected to an output of the isolator 111. The RX terminal is connected to one of inputs in a W-CDMA receiving unit 121. The SW terminal is connected to the switch 113.

Typically, the filter, the radio frequency power amplifier, and the directional coupler are provided on a substrate as discrete components. Instead, in order to build a smaller wireless circuit unit, proposed is a radio frequency module which uses a multi-layer board to integrate the radio frequency power amplifier and the filters placed in the vicinity of the radio frequency power amplifier.

It is noted that the prior arts of above invention are, for example, Patent Literature 1 (See Japanese Unexamined Patent Application Publication No. 2002-43813) and Patent Literature 2 (See Japanese Unexamined Patent Application Publication No. 2006-73673).

### SUMMARY OF THE INVENTION

Unfortunately, integration of components in the radio frequency module causes problems such as signal interference and capacity deterioration. CDMA and W-CDMA involve frequent control of transmission power since, using the systems, the interference with the power of another mobile terminal deteriorates the transmission quality. The power control is to (i) obtain a power amplified by the radio frequency power amplifier and reduced by the directional coupler to one thirtieth to one hundredth of the obtained power, (ii) feed back the obtained power signal to the RFIC, (iii) convert the power, by a power detector included in the RFIC, from electric power to voltage to monitor the output power of the mobile terminal, (iv) compare, by the baseband unit, the output power with a control signal provided from a base station and control the output power level of the RFIC, and (v) optimize a radio wave provided from the mobile-phone terminal. Thus, in addition to the accuracy problem, the directional coupler in the radio frequency module is susceptible to interference with the signals from other integrated components.

Furthermore, when the isolator is omitted, a reflective wave from the end of the antenna bounces back to the directional coupler. This causes a significant effect in detecting the transmission power. In order for accurate detection of the transmission power, the direction of the directional coupler is an important factor.

Patent Literature 1 discloses an example of a radio frequency module having a radio frequency power amplifier and a directional coupler both included in a single multi-layer board. In this example, the upper-layer portion of the radio frequency module has the radio frequency power amplifier and the lower-layer portion of the radio frequency module has the directional coupler. A main line and a sub line forming the directional coupler are vertically arranged with each having a different line width. Accordingly, Patent Literature 1 shows how the directional coupler improves its coupling accuracy. Patent Literature 1, however, fails to disclose the isolation between the radio frequency power amplifier and the directional coupler, and a counter measure against interference of outside noise with the directional coupler. In addition, the radio frequency module in Patent Literature 1 is difficult to be manufactured in a low profile since (i) the radio frequency power amplifier and the directional coupler are respectively formed in the upper and the lower layers from the middle of the multi-layer board, and (ii) this structure requires many layers.

Patent Literature 2 discloses an example of a radio frequency power amplifier, a directional coupler, a filter for transmission and a filer for reception, and an antenna switch all included in a single multi-layer board. This example shows reduction in interference through a ground layer, since (i) an inner layer ground pattern for the radio frequency power amplifier and (ii) an inner layer ground pattern for the filter separating the transmission and the reception and for the directional coupler are separated with each other. Both of the inner layers are in the same layer. However, this example fails to disclose the isolation between the radio frequency power amplifier and the directional coupler and the structure of the directional coupler.

The present invention is conceived in view of the above problems and has an object to offer a radio frequency module having a radio frequency power amplifier and a directional coupler integrated and, in particular, a small and inexpensive radio frequency module in which the radio frequency power amplifier and the directional coupler can provide excellent characteristics, and a wireless device equipped with the radio frequency module.

In order to achieve the above object, a radio frequency module according to an aspect of the present invention includes: a multi-layer board which includes two or more dielectric layers; a radio frequency power amplifier which is formed on an upper-most layer of the multi-layer board; a directional coupler which is formed below the radio frequency power amplifier; a first ground layer which is an inner layer between the radio frequency power amplifier and the directional coupler; a bias line which is (i) formed in a layer including the directional coupler, and (ii) used for the radio frequency power amplifier; and a thermal via which is (i) provided between the bias line and the directional coupler and (ii) used for the radio frequency power amplifier.

The directional coupler has the main line formed above the sub line. The first ground layer does not work as a ground, but works as a distributed elemental model having a certain degree of impedance. Thus, an unnecessary signal from the radio frequency power amplifier interferes with the directional coupler. Compared with the signal level of the radio frequency power amplifier whose signal is supplied in the main line provided below the first ground layer, the signal level of the unnecessary signal is significantly lower. In addition, both of the signals share the common mode. Thus, the unnecessary signal does not have much effect on the signal in the main line. Furthermore, the main line and the sub line are physically distant with each other, which gives very little effect on the directional coupler with respect to its direction and coupling.

Moreover, the thermal via also works as a ground via for the radio frequency power amplifier. Thus, the thermal via is provided between the bias line of the radio frequency power amplifier and the directional coupler. Accordingly, the bias line and the directional coupler are fully isolated with each other, eliminating the need for forming the bias line on a layer on which directional coupler is not formed.

The radio frequency module may further include a ground via which is provided (i) between the first ground layer and a second ground layer which is provided below the directional coupler, and (ii) between the directional coupler and an end of the multi-layer board. This structure contributes to reducing the effect of exogenous noise to the directional coupler. Furthermore, the ground via can improve the effect of the first ground layer as a ground, which contributes to improving the performance of the radio frequency power amplifier.

The present invention relates to a radio frequency module having a radio frequency power amplifier and a directional coupler integrated in a multi-layer board. More particularly, the present invention provides (i) a small, inexpensive, and high-performance radio frequency module having the radio frequency power amplifier, the main line and the sub line of the directional coupler, and a ground via which are optimally arranged, and (ii) a small and inexpensive wireless device equipped with the radio frequency module.

### FURTHER INFORMATION ABOUT TECHNICAL BACKGROUND TO THIS APPLICATION

The disclosure of Japanese Patent Application No. 2010-218182 filed on Sep. 29, 2010 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 depicts a cross-sectional view of a typical radio frequency module of the present invention;

FIG. 2 depicts a development view of a multi-layer board in the typical radio frequency module of the present invention;

FIG. 3 depicts a block diagram of a typical W-CDMA wireless unit; and

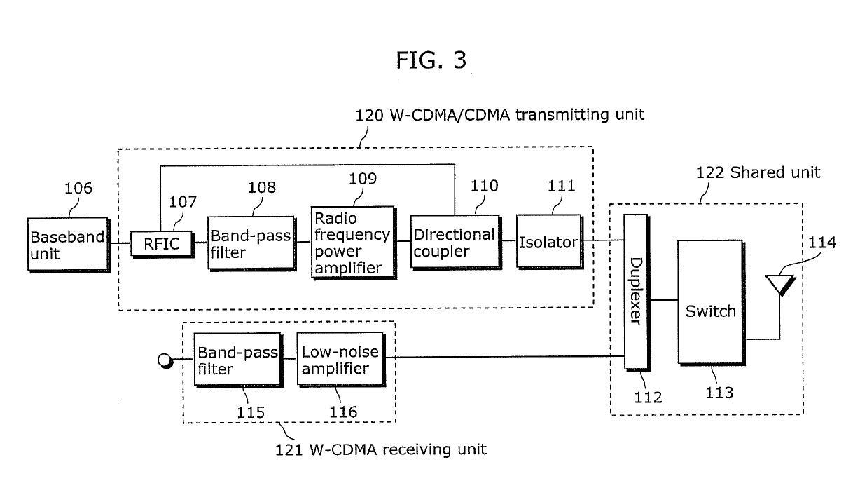

FIG. 4 depicts a typical multi-layer board.

### DESCRIPTION OF THE PREFERRED EMBODIMENTS

### Embodiment 1

Described hereinafter is a radio frequency module according to Embodiment 1 of the present invention with reference to the drawings.

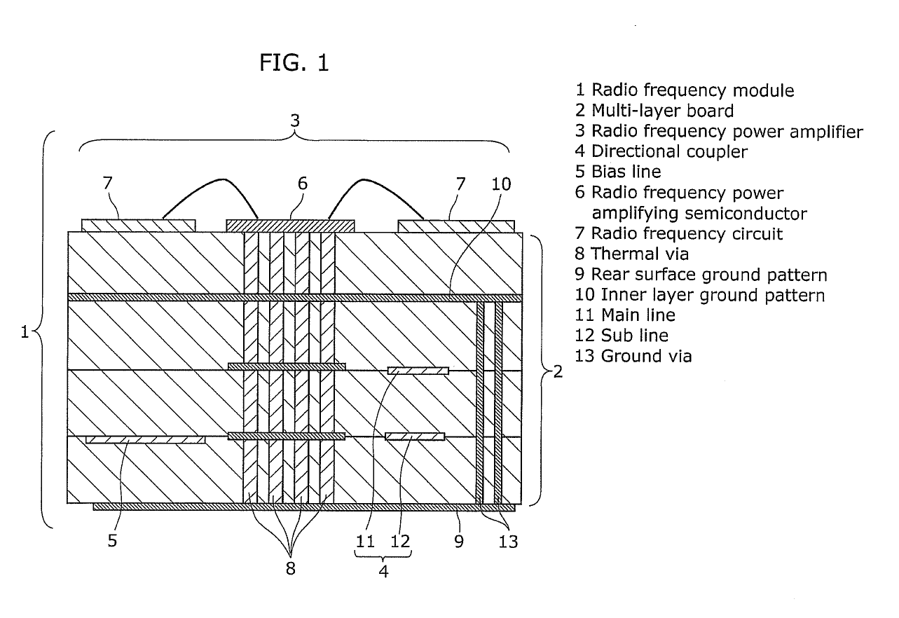

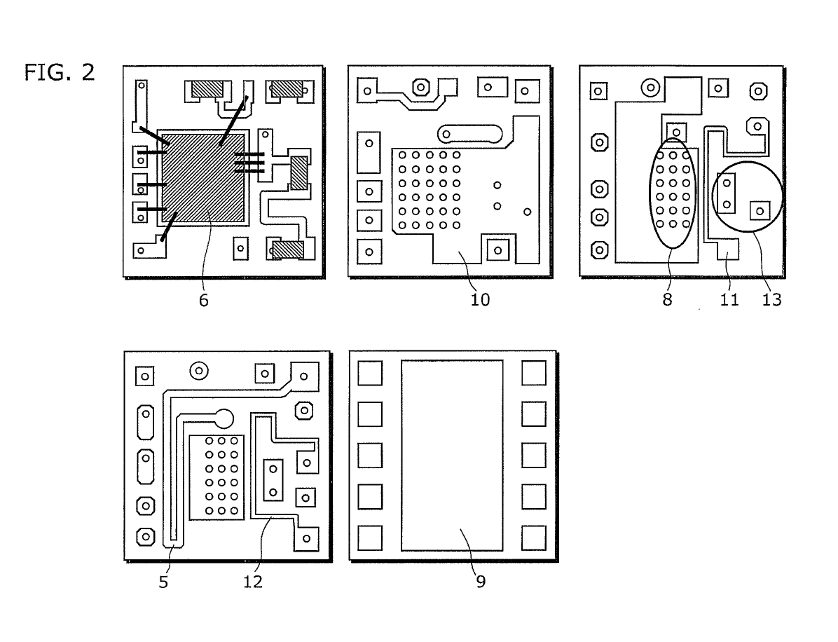

FIG. 1 depicts a cross-sectional view of a radio frequency module of the present invention. FIG. 2 depicts a development view of a multi-layer board in the radio frequency module.

A radio frequency module 1 in FIG. 1 includes a multi-layer board 2, a radio frequency power amplifier 3 provided on the top of the upper-most layer of the multi-layer board 2, a directional coupler 4, and a line 5. The directional coupler 4 monitors a signal provided from the radio frequency power amplifier 3 formed in inner layers of the multi-layer board 2. The line 5 supplies a bias to the radio frequency power amplifier 3. Examples of the multi-layer board 2 includes, but not limited to, multi-layer boards made of ceramic or resin. Any multi-layer board is usable as far as a wiring pattern is formed thereon. On the upper-most layer of the multi-layer board 2, implemented is a radio frequency power amplifying semiconductor device 6 included in the radio frequency power amplifier 3. A wiring pattern and devices such as a capacitor, an inductor, and a resistor form a radio frequency circuit 7. Since the radio frequency power amplifying semiconductor device 6 develops heat, two or more thermal vias 8 are provided below the radio frequency power amplifying semiconductor device 6. The thermal vias 9 lead to a rear surface ground pattern 9 of the multi-layer 2, and act as ground vias. An inner layer ground pattern 10 in the multi-layer board 2 acts as a ground for the radio frequency power amplifier 3 on the upper-most layer. The inner layer ground pattern 10 is also connected to the thermal vias 8. The directional coupler 4 is provided below the inner layer ground pattern 10 and a radio frequency matching circuit 7. The directional coupler 4 includes a main line 11 and a sub line 12. The main line 11 is formed below the inner layer ground pattern 10. The sub line 12 is formed below the main line 11. The main line 11 and the sub line 12 are vertically arranged to form the directional coupler 4. Table 1 shows characteristics of the directional coupler 4 when (i) the upper layer includes the main line 14 and the lower layer includes the sub line 12, and (ii) the upper layer includes the sub line 12 and the lower layer includes the main line 14.

TABLE 1

| | Upper layer: | Upper layer: |
|---|---|---|
| | Main line | Sub line |
| Structure of directional | Lower layer: | Lower layer: |
| coupler | Sub line | Main line |
| Coupling C (dB) | 20.6 dB | 19.9 dB |
| Direction D (dB) | 23.5 dB | 16.6 dB |

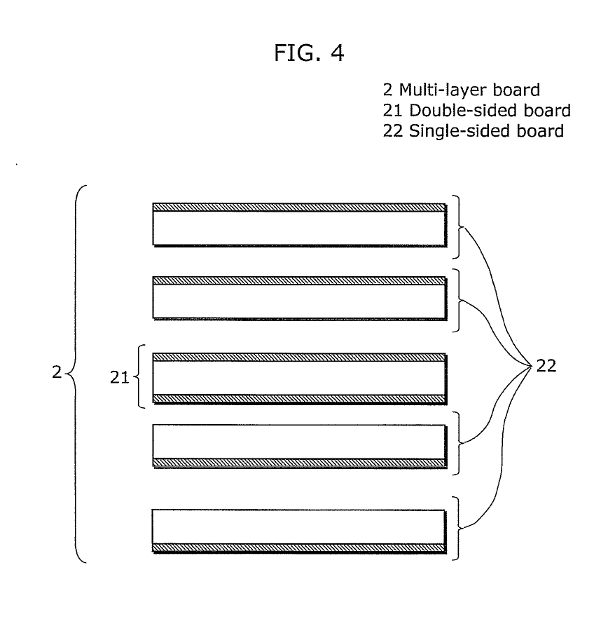

Unfortunately, a directional coupler formed in a multi-layer board and vertically arranged would not achieve high accuracy due to position displacement caused by (i) lamination deviation, and (ii) variation in wiring pattern width since wires are patterned in different layers. However, such a problem is overcome with a main line and a sub line each formed in one side of double-sided board. FIG. 4 depicts a typical multi-layer board. The multi-layer board 2 is formed with a double-sided board 21 placed in the middle and single-sided boards 22 laminated over and under the double-sided board 21. Thus, first, the main line 11 and the sub line 12 of the directional coupler is formed on the double-sided board 21. Then, each used for the ground pattern, the wiring pattern for the radio frequency power amplifier, and the rear surface pattern, the single-sided boards 22 are laminated over and under the double-sided board 21 to form the radio frequency module 1. The single-sided boards 22 do not have to be laminated in the same number over and under the double-sided board 21. When the single-sided boards 22 are made of resin and thus have relatively low modulus, the single-sided boards 22 may be laminated in the same number over and under the double-sided board 21, since deformation such as warpage and distortion might occur to the multi-layer board. Forming the directional coupler 4 on double-sided board 21 prevents the position displacement caused by the lamination deviation. Furthermore, the wiring pattern can also be simultaneously formed, and no variation is found between the main line and the sub line in pattern width. Thus, there is no problem of designing the main line and the sub line having the same linewidth.

The inner layer ground pattern 10 does not work as an ideal ground radio frequency-wise, and equals to the distributed elemental model having a certain degree of impedance. Thus, when the radio frequency power amplifier 3 on the upper-most layer operates, an unnecessary radio frequency signal leaks to the inner layer ground pattern 10. In order to reduce the effect of the unnecessary radio frequency signal, the main line 11 of the directional coupler 4 is provided directly below the inner layer ground pattern 10. Compared with the signal level of the radio frequency power amplifier 3 whose signal is sent in the main line 11, the level of the unnecessary signal is significantly lower. In addition, both of the signals share the common mode. Thus, the unnecessary signal has not much effect on the signal in the main line 11. Furthermore, the main line 11 and the sub line 12 are physically distant with each other, which give very little effect on the directional coupler 4 with respect to its direction and coupling.

The bias line 5 supplies a bias to the radio frequency power amplifying semiconductor device 6. In order to ideally prevent the radio frequency signal from leaking, the bias line 5 needs to be λ/4 long such that the relationship of the impedance is open in relation to the bias line 5 from the radio frequency power amplifying semiconductor device 6. In the radio frequency module 1 to which downsizing is requested, the bias line 5 is printed also on an inner layer of the multi-layer board. However, there is no room for printing the bias line 5 of λ/4. Actually, the bias line 5 is shorter than λ/4 and is used as part of a matching circuit. Thus, the radio frequency signal also leaks to the bias line 5. In the case where the bias line 5 is formed in a layer above or below the directional coupler 4, both of the bias line 5 and the directional coupler 4 suffer from the interference of the radio frequency signal. Thus, a ground layer needs to be additionally provided between the bias line 5 and the directional coupler 4 in order to isolate them with each other. Because if the bias line 5 is formed above the main line 11, both of the bias line 5 and the main line 11 would suffer from the interference of the radio frequency signal, resulting in deterioration in radio frequency characteristics. If the bias line 5 is formed below the sub line 12, the directional coupler 4 would be significantly affected in detecting signals. Moreover, the radio frequency power amplifier 3 often includes two-or-more-stage amplifiers. The interference of the bias line 5 with the multi-stage radio frequency power amplifier 3 needs to be carefully monitored. When the radio frequency power amplifier 3 is in two stages, for example, a signal amplified by the amplifier in the first stage and a signal amplified by both of the amplifier in the first stage and the amplifier in the second stage are significantly different in phase. When those signals interfere, the radio frequency characteristics deteriorate and operations of the amplifiers become unstable. Accordingly, a ground pattern needs to be provided between the bias line 5 and the radio frequency power amplifier 3 to isolate them. Forming the bias line 5 on the layer above or below the directional coupler 4 is not suitable to downsizing the radio frequency power amplifier 3. Concurrently, when the bias line 5 is formed on the same layer on which the directional coupler 4 is formed, the bias line 5 and the radio frequency power amplifier 3 can be isolated with each other by the layer to which the inner layer ground pattern 10 is provided. The directional coupler 4 and the bias line 5 may be arranged distant with each other since there is little coupling part when the bias line 5 is vertically arranged with respect to the main line 11 or the sub line 12. Furthermore, when the bias line 5 is horizontally arranged with respect to the main line 11 or the sub line 12, the directional coupler 4 and the bias line 5 may be arranged distant with each other or may have a ground pattern provided there between, since the coupling between the lines becomes great and the lines interface with each other. Instead of providing an extra ground pattern, the use of thermal visa 8 contributes to making the radio frequency power amplifier 3 smaller. Here, the bias line 5 is provided across from the directional coupler 4 with respect to the thermal visa 8. A ground via 13, which connects the inner layer ground pattern 10 with a rear surface ground pattern 9, may be provided between the directional coupler 4 and an end of the multi-layer board. The ground via 13 can improve the effect of the inner layer ground pattern 10 as a ground, which contributes to reducing the deterioration of the radio frequency performance of the radio frequency power amplifier 3. In addition, the ground via 13 contributes to reducing the effect of exogenous noise from peripheral components to the directional coupler 4, when the radio frequency power amplifier 3 is embedded in a wireless device.

Although only an exemplary embodiment of this invention has been described in detail above, those skilled in the art will readily appreciate that many modifications are possible in the exemplary embodiment without materially departing from the novel teachings and advantages of this invention. Accordingly, all such modifications are intended to be included within the scope of this invention.

### INDUSTRIAL APPLICABILITY

As described above, the present invention is effective in manufacturing a small and inexpensive radio frequency module.

What is claimed is:

1. A radio frequency module comprising:
a multi-layer board which includes two or more dielectric layers;
a radio frequency power amplifier which is formed on an upper-most layer of said multi-layer board;
a directional coupler which is formed below said radio frequency power amplifier;
a first ground layer which is an inner layer between said radio frequency power amplifier and said directional coupler;
a bias line which is (i) formed in a layer including said directional coupler, and (ii) used for said radio frequency power amplifier; and
a thermal via which is (i) provided between said bias line and said directional coupler and (ii) used for said radio frequency power amplifier.

2. The radio frequency module according to claim 1,
wherein said directional coupler includes a main line and a sub line each formed in a different layer, and
said main line is formed above said sub line.

3. The radio frequency module according to claim 1, further comprising
a ground via which is provided (i) between said first ground layer and a second ground layer which is provided below said directional coupler, and (ii) between said directional coupler and an end of said multi-layer board.

4. The radio frequency module according to claim 1,
wherein said multi-layer board is formed of a double-sided board and one-sided boards laminated over and under said double-sided board, said double-sided board having a wiring pattern fabricated on each side, and each of said one-sided boards having a wiring pattern fabricated only on one side, and
said directional coupler is formed on said double-sided board.
